(19) United States
(12) Patent Application Publication
(10) Pub. No.: US 2006/0059072 A1
(43) Pub. Date: Mar. 16, 2006

(54) Pattern matcher

(75) Inventor: Yuri Boglaev, Laurel, MD (US)

Correspondence Address: MILES & STOCKBRIDGE PC, 1751 PINNACLE DRIVE, SUITE 500, MCLEAN, VA, 22102-3833, US

(73) Assignee: Ameritrade IP Company, Inc., Omaha, NE (US)

(21) Appl. No.: 11/224,930

(22) Filed: Sep. 14, 2005

Related U.S. Application Data
(60) Provisional application No. 60/609,258, filed on Sep. 14, 2004.

(51) Int. Cl. G06Q 40/00

(52) U.S. Cl. 705/35

(57) ABSTRACT

A user can select from one of a number of predefined patterns, create a new pattern, or import a pattern from existing data. With a time interval specified, a search is performed and comparable patterns identified in one or more streams of securities data. Filtering can be performed before and/or after the searching with, for example, a number of the closest pattern matches displayed to the user. These closest pattern matches can be displayed graphically, in a table, in a list, or in general in any manner which may be useful for analysis by the user. One or more of the system and the user can also place a trade (buy or sell) of one or more of the identified closest matches.

### RELATED APPLICATION DATA

This application claims the benefit of and priority under 35 U.S.C. §119(e) to U.S. Patent Application No. 60/609,258, filed Sep. 14, 2004, entitled “Pattern Matcher,” which is herein incorporated by reference in its entirety.

### BACKGROUND OF THE INVENTION

1. Field of the Invention

This invention generally relates to data analysis. In particular, this invention relates to the determination and display of information having comparable patterns.

2. Description of Related Art

Technical analysis of the market is the examination and study of price movements to guess future price movements. This guess can be based on a historical and/or a real-time view of price movements. Technical Analysts are sometimes referred to as “Chartists” because they typically rely on charts for analysis and market predictions. Technical analysis is usually applied to stocks, bonds, commodities, futures, or in general any tradable instrument where there are price fluctuations. This technical analysis is usually limited to a time frame, although this time frame can be anything from intraday, which can, for example, be based on the tick, or in five-minute, 10-minute, hourly, daily, weekly, biweekly or monthly internals or any other time period for which price data is available, including historical information.

Since the objective of market analysis is an attempt to predict future price changes, Technical Analysts traditionally weigh price changes associated with a particular stock very highly under the assumption that variations in price typically occur before changes in that stock's price. One tool used for the analysis of these trends or patterns in the price are charts. Charts are simply a graph of the price of a particular stock, commodity, or the like, over a time frame. Charts are usually configured so that the X-axis represents a time frame with the Y-axis representing price point. Any security which has a price that changes over a given period of time can be charted for technical analysis.

Chart patterns, some of which are well known and are used on a regular basis by Technical Analysts, illustrate in graphical form trends of a commodity in the marketplace. Some of the typical and well known industry patterns utilized as indicators are the bump and run pattern, double top, double bottom, head and shoulders top, head and shoulders bottom, cup with handle, flag, symmetrical triangle, ascending triangle, descending triangle, price channel, falling wedge, rising wedge, rounding bottom, triple top, triple bottom, rectangle, bear move, bull move.

### SUMMARY

The trading of stocks is generally divided into two different categories. The first category is where the majority of trading is done face-to-face on a trading floor. This type of trading referred to as a “listed” exchange. Orders generally come in through brokerage firms that are members of the exchange and flow down to floor brokers who go to a specific spot on the floor where the stock trades. At this specific location there is a “specialist” who matches buyers and sellers. Prices are generally determined using an auction type method.

The second type of exchange is an over-the-counter market, synonymous with the NASDAQ® exchange. The over-the-counter markets have no central location or floor and trading is done electronically through a network of dealers. With the over-the-counter market, brokerages act as “market makers” for various stocks where the market maker provides continuous bid and ask prices within a prescribed percentage spread for shares for which they are designated to make a market.

As discussed above, market makers provide continuous bid and offer prices. Furthermore, market makers enhance stock liquidity and assist in long-term growth of the market.

For over-the-counter trades, there are a variety of ways that security prices are quoted to traders. These various ways can depend on, for example, the amount of information desired, access rights, and fees paid to the quoting service.

Associated with each market are data feeds that provide various information such as the stock symbol, last price, change information, volume information, and high and low price information. Viewing the price and size movement of particular stocks allows market participants users to closely follow, and sometimes predict, the direction and flavor of the market and/or a particular stock.

To enhance the information available to a user, such as a trader, the exemplary systems and methods of this invention match a selected pattern to available data. As previously discussed, this available data can be a stock, commodity, security, or in general any data that has information which varies over a given period of time. For example, this information in the securities environment could be price information, volume information, or in general any indicator which may be used to assist in the prediction of, or analysis of, market trends.

More specifically, a user can select from one of a number of predefined patterns, create a new pattern, or import a pattern from existing data. With a time interval specified, a search is performed and comparable patterns identified. Filtering can be performed before and/or after the searching with, for example, a number of the closest pattern matches displayed to the user. These closest pattern matches can be displayed graphically, in a table, in a list, or in general in any manner which may be useful for analysis by the user. The exemplary systems according to this invention further allow the placement of an order (buy or sell) of one or more of the identified closest matches.

Accordingly, exemplary aspects of this invention relate to the analysis of information.

Additional exemplary aspects of the invention relate to the analysis and comparison of patterns.

Additional exemplary aspects of the invention relate to pattern matching in a securities environment.

Further exemplary aspects of the invention relate to providing a pattern matching tool to assist with market trend analysis and order placement.

Still further exemplary aspects of the invention relate to automated triggering of an event based on a proximity to a pattern match.

Exemplary aspects of the invention also relate to real-time, near real-time and historical pattern analysis.

Further exemplary aspects of the invention relate to providing various user interfaces that allow for the creation and/or modification of patterns.

Still further aspects of the invention relate to user interfaces that display one or more of existing patterns, acquired patterns, custom patterns, as well as the patterns of one or more closest matches.

These and other features and advantages of this invention are described in, or are apparent from, the following detailed description of the exemplary embodiments.

### BRIEF DESCRIPTION OF THE DRAWINGS

The exemplary embodiments of the invention will be described in detail, with reference to the following figures wherein:

FIG. 1 illustrates an exemplary pattern matching system according to this invention;

FIG. 2 is a block diagram illustrating in greater detail the pattern matcher engine according to this invention;

FIG. 3 illustrates an exemplary user interface of the pattern matching system according to this invention;

FIG. 4 illustrates an exemplary user interface showing an input pattern and a best match according to this invention;

FIG. 5 illustrates an exemplary user interface showing the action menu according to this invention;

FIG. 6 illustrates an exemplary user interface showing the similarity filter menu according to this invention;

FIG. 7 illustrates an exemplary user interface highlighting the volume filter menu according to this invention;

FIG. 8 illustrates an exemplary user interface highlighting the price filter menu according to this invention;

FIG. 9 illustrates an exemplary interface highlighting the time interval according to this invention;

FIG. 10 illustrates an exemplary interface associated with symbol pattern matching according to this invention;

FIG. 11 is a flowchart illustrating an exemplary method of the general operational flow of the pattern matching system according to this invention;

FIG. 12 is a flowchart illustrating in greater detail the select pattern step of FIG. 11 according to this invention;

FIG. 13 is a flowchart illustrating in greater detail an alternative to the select pattern step in FIG. 11 according to this invention;

FIG. 14 is a flowchart illustrating yet another alternative to the select pattern step of FIG. 11 according to this invention; and

FIG. 15 is a flowchart illustrating in greater detail the pattern match search of FIG. 11 according to this invention.

### DETAILED DESCRIPTION

The exemplary systems and methods of this invention will be described in relation to a pattern matching system. However, to avoid unnecessarily obscuring the present invention, the following description omits well-known structures and devices that could be shown in block diagram form or otherwise summarized. For the purpose of explanation, numerous specific details are set forth in order to provide a thorough understanding of the present invention. It should be appreciated, however, that the present invention may be practiced in a variety of ways beyond the specific details set forth herein. For example, while the systems and methods of this invention will be described in-relation to the applicability of the invention to securities pattern matching, it should be appreciated that the system can be adapted to analyzing any type of information that varies over time. Moreover, it should be appreciated that the system can be adapted to any type of trading in any foreign or domestic market.

Furthermore, while the exemplary embodiments illustrated herein show the various components of the pattern matching system colocated, it is to be appreciated that the various components of the system can be located at distant portions of a distributed network, such as a telecommunications network and/or the Internet, or within a dedicated pattern matching system. Thus, it should be appreciated that the various components illustrated herein can be combined into one or more devices or colocated on a particular node of a distributed network such as a telecommunications network, the Internet, a private network, a secured or unsecured network, or any combination thereof. It will be appreciated from the following description, and for reasons of computational efficiency, that the components of the pattern matching system can be arranged at any location within a distributed network without effecting the operation of the system.

Moreover, it should be appreciated that the various links connecting the elements can be wire or wireless links or any combination thereof, or any other known or later-developed element(s) that is capable of supplying and/or communicating data to and from the connected elements. Additionally, the terms module and engine as used herein can refer to any known or later-developed hardware, software, or combination of hardware and software that is capable of performing the functionality associated with the element.

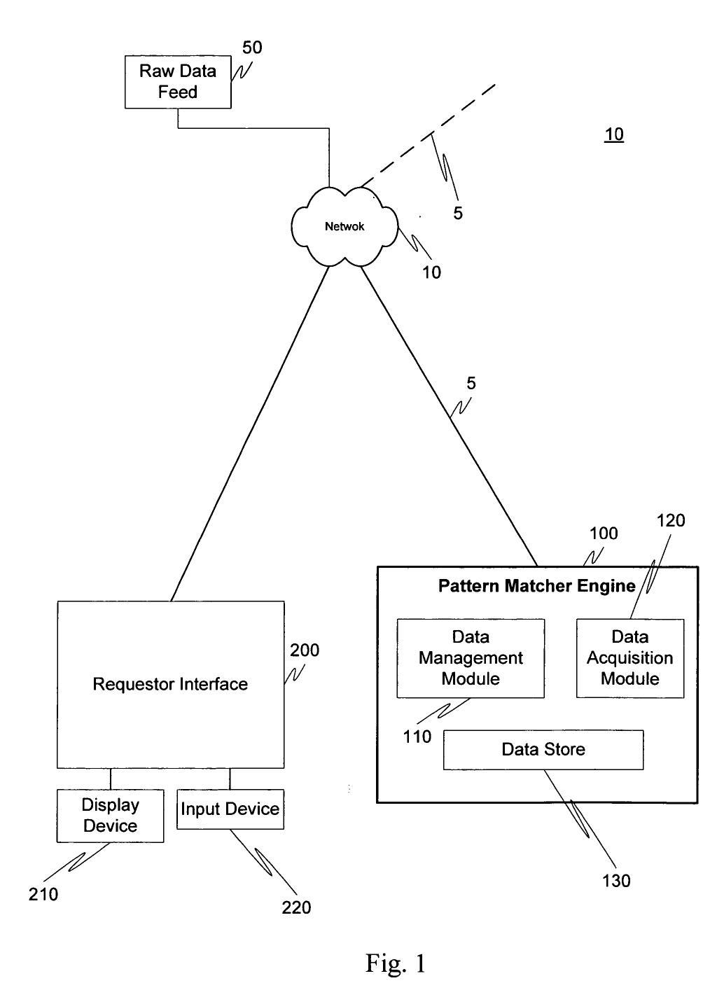

FIG. 1 illustrates an exemplary embodiment of the pattern matching system 10. The pattern matching system 10 comprises a pattern matcher engine 100, a requester interface 200, and a raw data feed 50 all interconnected by one or more links 5 and one or more networks 10. The pattern matcher engine 100 comprises a data management module 110, a data acquisition module 120 and a data store 130. The requester interface 200 is further connected to one or more displayed devices 210, such as a monitor, and one or more input devices 220, such as a mouse, keyboard, drawing tool, or the like.

In operation, the pattern matcher engine 100 receives data from one or more raw data feeds 50. As previously discussed, this raw data feed can be securities information. The raw data from the one or more data feeds is stored, in conjunction with the data management module 110, in the data store 130.

A user, utilizing the requestor interface 200, selects a pattern for which one or more closest matches are desired. Upon receipt of this request, and a corresponding time interval, the pattern matcher engine 100, in cooperation with the data acquisition module 120 acquires data for the requested time interval. This time interval can be real-time, historical, or specify a future time interval during which pattern matching is desired. The pattern matcher engine 100 then performs a pattern match search and provides the results, via link 5 and network 10, to the user at the requestor interface 200. The results can then be displayed, for example, on display device 210.

The requestor interface 200 can operate, for example, as a client in a client-server type architecture with the pattern matcher engine 100 acting as the server. Additionally, the requestor interface 200 can be, for example, a personal computer having a processor, memory, I/O interface, and other well-known components that are not illustrated. Moreover, the requestor interface 200 could be an application, such as a Java® applet that provides an interface between the user and the pattern matcher engine 100. However, and in general, it should be appreciated that requestor interface 200 can be embodied in any configuration and could also be part of or connected directly to the pattern matcher engine.

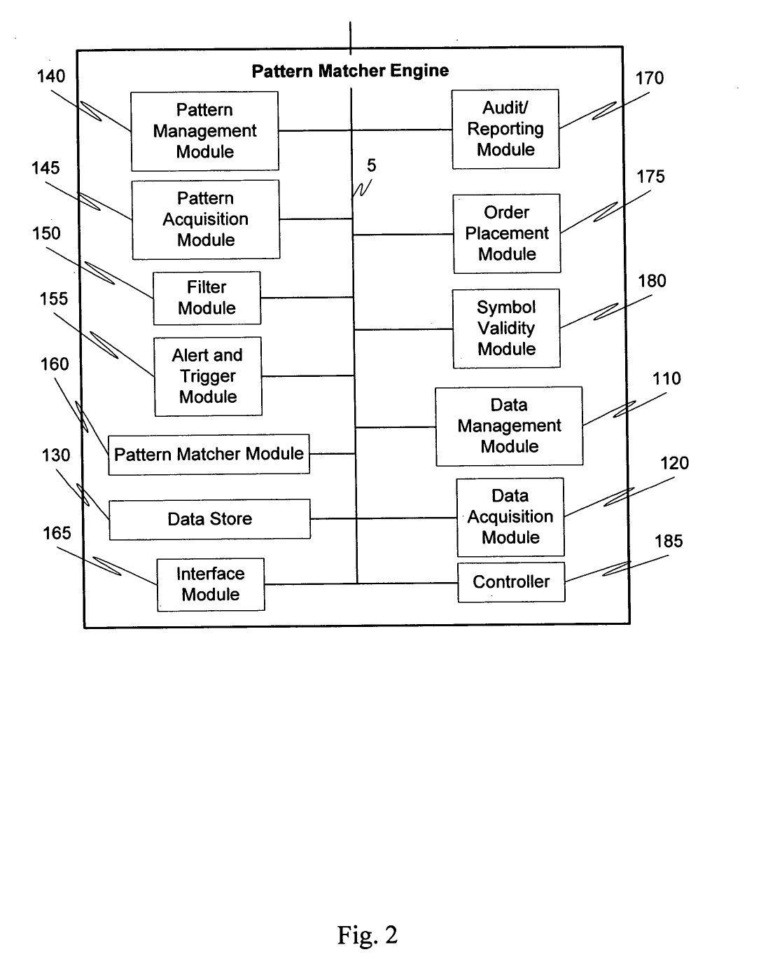

FIG. 2 outlines in greater detail additional components of the pattern matcher engine 100. As illustrated above, the pattern matcher engine 100 comprises a data management module 110, a data acquisition module 120, and a data store 130. Furthermore, the pattern matcher 100 can comprise a pattern management module 140, a pattern acquisition module 145, a filter module 150, an alert and trigger module 155, a pattern matcher module 160, an interface module 165, an audit/reporting module 170, an order placement module 175, a symbol validity module 180, and a controller/processor 185.

The pattern management module 140 manages the various types of patterns that are available to a user. As previously discussed, these patterns can include commonly known, or canned patterns, such as the double top, double bottom, falling wedge, rising wedge, flag, or the like. Users can select one or more of these patterns which are then used as the basis of the comparison in the pattern matching system. The pattern management module 140 also allows the editing, re-naming, deletion, and in general any management of the various patterns that are provided to, created by, or acquired by a user. The pattern management module 140 also allows these various patterns to be shared amongst one or more users.

The pattern acquisition module 145 allows a user to create a pattern through the use of a user interface. For example, the user can be provided with a two-dimensional space having an X and a Y axis upon which a pattern can be drawn. The drawn pattern can be received via the input device 220 and edited and stored at which point it is managed by the pattern management module 140.

In addition, the pattern acquisition module 145 allows a user to enter, for example, a symbol and a time period, with the pattern acquisition module determining the pattern of that symbol over the time period. This pattern can then be stored as a custom pattern and managed by the pattern management module 140.

The filter module 150 provides users the ability to filter results of the pattern matcher engine 100. The one or more filters described herein can be associated with a particular pattern and/or can be applied to a grouping of results before or after the pattern matching analysis has been performed. The various types of filters include, but are not limited to, a price filter, a time interval filter, a projected volume filter, a rate of change of volume filter, a similarity filter, an exchange filter, a watch list filter, a market session filter and a number of top results filter. Each filter has the ability to be updated and modified regardless of the pattern selected by the user. For example, if a user selects a canned pattern, they could have the ability to change the time interval, price criteria, or the like. In general, any filter, be it user defined or one of the pre-stored filters, have one or more attributes that can be edited and modified by the user.

The price filter allows users to select upper and lower thresholds of the price of a security. The price filter can also be configured such that the user specifies a center point around which a range of pattern matches are provided.

The time interval filter can filter results to any time interval including a historical period of time, real-time, or any combination thereof. Moreover, the time interval filter can be configured to look at a period that will occur in the future and the system placed in a “waiting mode” to perform analysis at the appropriate point in time.

The projected volume filter allows a user to select a range for projected volume having a lower threshold and an upper threshold. The projected volume filter can be based on a projected volume assuming linear volume throughout the day.

The rate of change volume filter allows a user to select a rate of change of volume. This can range from any rate of change to values confined by upper and lower thresholds.

The similarity filter allows a user to select a range for the similarity of the pattern matching that can be any amount between zero and 100%.

The exchange filter allows a user to select, for example, one or more securities exchanges or, more generally, any one or more portion or portions of one or more raw data feed(s).

The watch list filter allows a user to select one or more watch lists from, for example, a portfolio management database as a filter. In this filter, user-defined criteria (patterns, filters, etc.,) could be applied to the securities listed in one or more watchlists instead of the universe of stocks.

The market session filter allows a user to select options for their market session such as regular session, pre-market session, post-market session, and/or all sessions. Once a user selects a particular session, the time interval setting can be limited to be consistent with the length of the selected market session.

The number of top results filter allows the number to specify the number of closest pattern matches to be displayed. This number can be any number from one to infinity however from a usability standpoint, it may be advantageous to limit the number of top results to less than 20.

The filter module 150 further allows the user to save settings that may be specific to one or more of the available filters. The user can also create new custom filters all of which can be saved and retained for current and future sessions. Moreover, if a user elects to save a pattern, the filter associated with that pattern can also be saved and associated therewith.

The alert and trigger module 155 allows users to set one or more custom alerts and operation triggers. These alerts can be, for example, audio, visual, e-mail, instant message, or any combination thereof. The alerts can be configured such that for example, when a particular pattern match is found that meets a specific filter requirement (if specified), an alert is sent to one or more users. In a similar manner, triggering allows the pattern matcher engine to perform an operation when one or more criteria are met. For example, the operation can be an order or trade trigger when a particular pattern match is found. The operation triggered by the alert and trigger module 155 can be fully automated or partially automated and require some level of user intervention.

The pattern matcher module 160 performs the pattern matching analysis on the received raw data from the raw data feed 50 and/or on data stored in the data store 130. In general, the pattern matcher module 160 obtains data for the time interval over which patterns are to be analyzed, determines a sampling rate and performs a normalization and an aggregation on demand for the specified time interval.

More specifically, a first step is to define the time window over which the search for a match will be carried out. A typical time interval is defined by a start and a finish point, for example, from 12:23:00 to 13:00:00, or, for example, the last 15 minutes, last week, last year, next Monday, or the like. For the latter examples, the pattern matcher engine 100 can make the actual calculations as to the exact start and stop times. This time window can be divided into time intervals, based on, for example, a grid size or number of nodes (sampling rate) that will give a time step value. The time step value is equal to the finish time minus the start time divided by the sampling rate.

Normalization and aggregation are performed over the specified time window. For this time window, information retrieved from the raw data feed is fetched and aggregation is performed according to the following formula on each node-sub interval (e.g., 32 subintervals, similar to the moving average).

$$Price = SUM \frac{( price [ I ] * volume [ I ] )}{SUM ( volume [ I ] )} ,$$

where I is the tick number in the subinterval.

If on the subinterval, there are no ticks, the price from a previous or next subinterval can be extrapolated. Normalization is performed according to:

$$NormalPrice = \frac{( Price - MIN )}{( MAX - MIN )}$$

where MIN and MAX are the minimum and maximum, respectively, price on the grid for the given time interval. Thus, all prices on subintervals after aggregation and normalization belong to the interval [0,1].

Next, the search for the best match is performed with an optimization technique based on a distance formula between a pattern and normal price for each symbol in accordance with:
Distance={square root over ((SUM(pprice−nprice))²)}
where pprice is the pattern price, nprice is the normal price for the node and SUM is the summation over the nodes. The best match is the symbol given by the minimum value of distance.

It should be appreciated however that additional algorithms can be utilized. An exemplary alternative is optimization in the time domain as proposed above with various distance definitions. Other optimization techniques could be used such as Fourier and/or multiresolution analysis.

The interface module 165 allows the pattern matcher engine to communicate with various other entities such as the raw data feed 50, the requestor interface 200, or in general any interface or other system.

The audit/reporting module 170 allows the pattern matcher engine 100 to generate audits and the ability to create reports based on, for example, the number of pattern match requests received, the number of obtained pattern matches, the breakdown of close pattern matches, system load, errors, or in general any aspect of the operation of the pattern matcher engine.

The order placement module 175 allows for order placement in conjunction with instructions received from the requestor interface 200 or, for example, automatically or semi-automatically at the direction of the alert and trigger module 155.

The symbol validity module 180 allows for symbols entered at the requestor interface 200 to be verified and to ensure that the symbol is a recognized symbol. If the symbol is not recognized, an error can be provided to the user at the requestor interface 200.

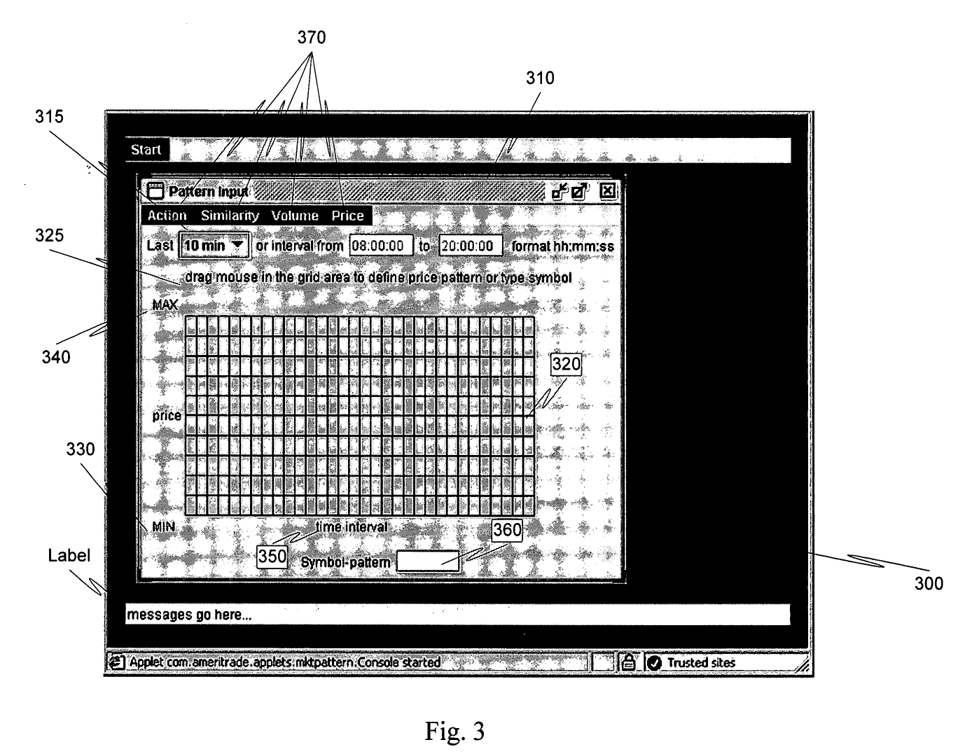

FIG. 3 illustrates an exemplary pattern matcher window 300. This pattern matcher interface 310 can be used by a user to enter a custom pattern, edit a pattern or to view stored patterns. The pattern matcher interface 310 includes a grid portion 320, which, on the X-axis is the time interval 350 and on the Y-axis the price point ranging from a minimum value 330 to a maximum value 340. The time period is illustrated in window 315. The pattern matcher interface 310 further includes a symbol-pattern dialog box 360 into which a symbol can be entered for use in conjunction with the acquiring pattern methodology discussed hereinafter. Also seen on the exemplary pattern matcher interface 310 are various filtering menus 370 that exemplararily include an action filter menu, a similarity filter menu, a volume filter menu, and a price filter menu. The interface can also include an instruction portion 325. The interface, and various interfaces illustrated hereafter, are not limited to containing the illustrated portions but rather can include any information as necessary to facilitate use of the pattern matcher system.

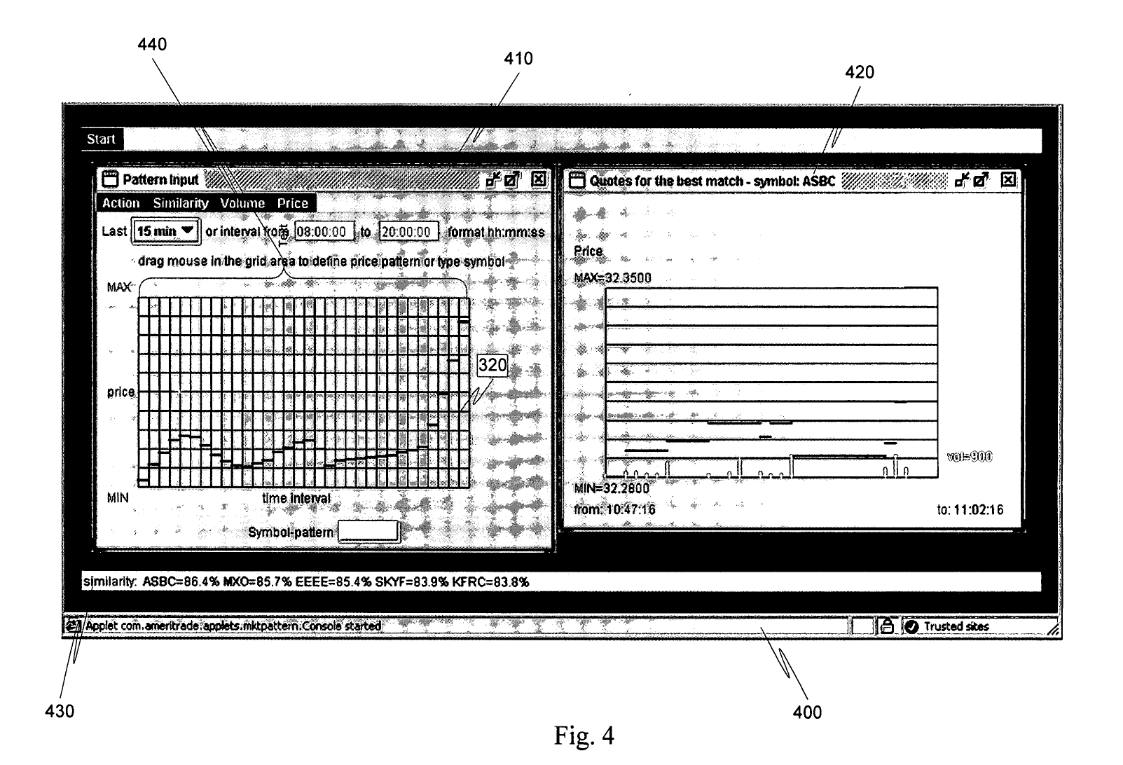

FIG. 4 illustrates a user interface 400 that includes an exemplary pattern matcher pattern interface 410 and a best match interface 420. In this exemplary embodiment, a pattern has been input and is shown on grid 320 as pattern 440. In the best match window 420, the closest match was found to be a symbol “asbc” with a minimum price of approximately 32.35 and a maximum price of approximately 32.28. The time period in which the pattern was found is illustrated in the best match window as well as the volume associated with that particular stock. Moreover, in window 430, the next closest matches are shown with their corresponding percentage of similarity to the requested pattern 440.

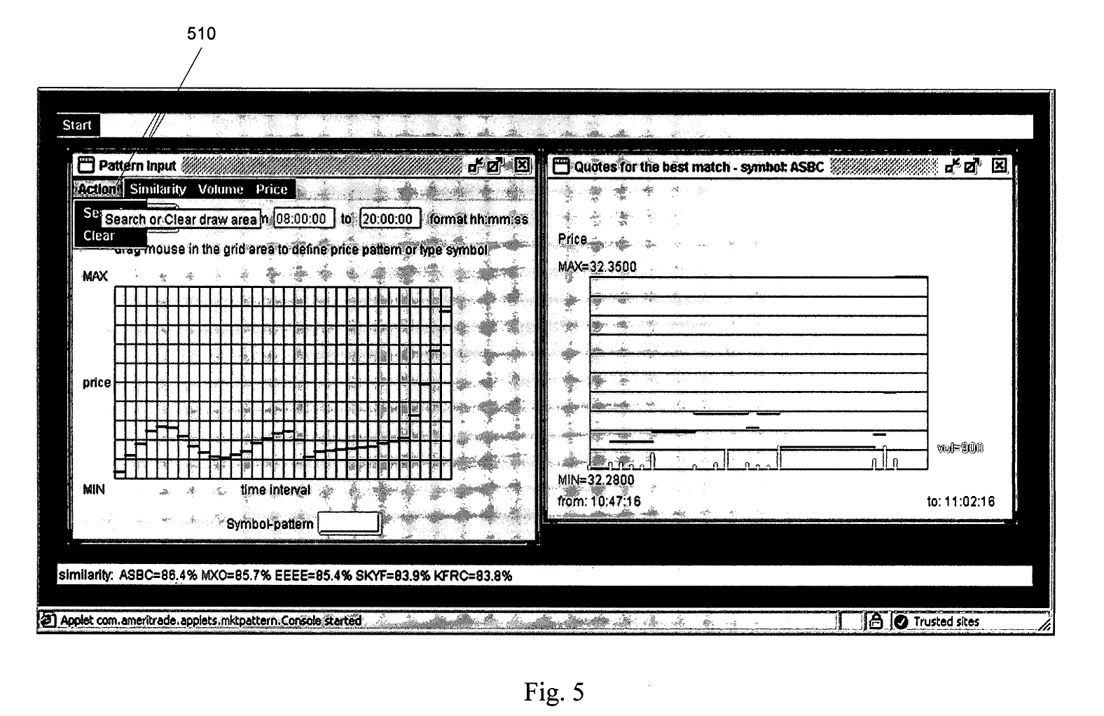

FIG. 5 illustrates an exemplary interface that highlights some of the exemplary actions available in the action drop down menu 510. These include selectable portions to, for example, allow searching or clearing the drawing area.

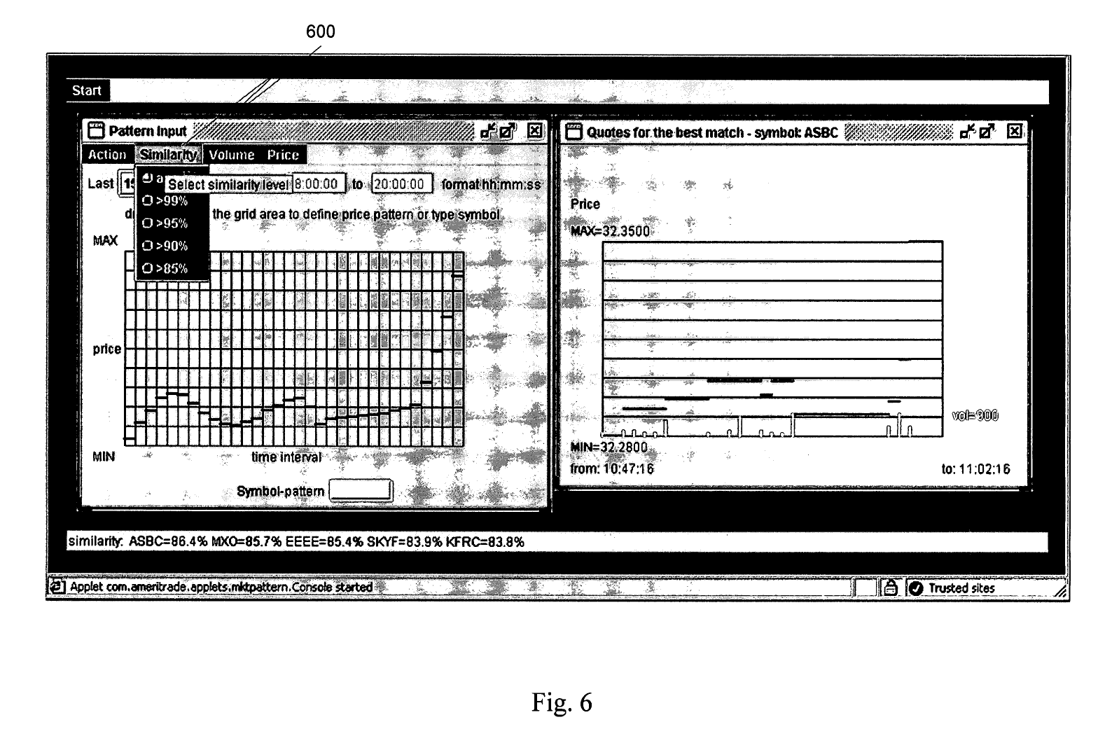

FIG. 6 highlights in greater detail the similarity menu 600. The similarity menu includes exemplary selectable portions where a user can select various similarity thresholds which are used to filter the results found by the pattern matcher engine.

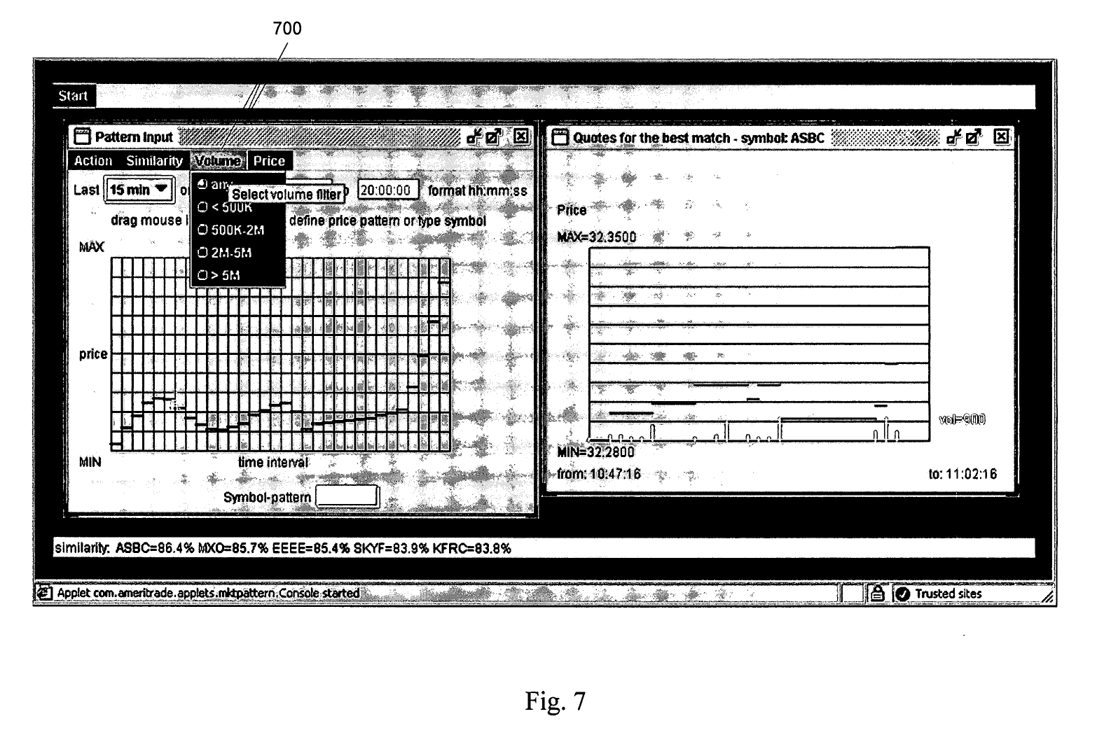

FIG. 7 illustrates in greater detail the volume menu 700 from which a user can select volume thresholds or ranges which are again used as filter criteria by the pattern matcher engine.

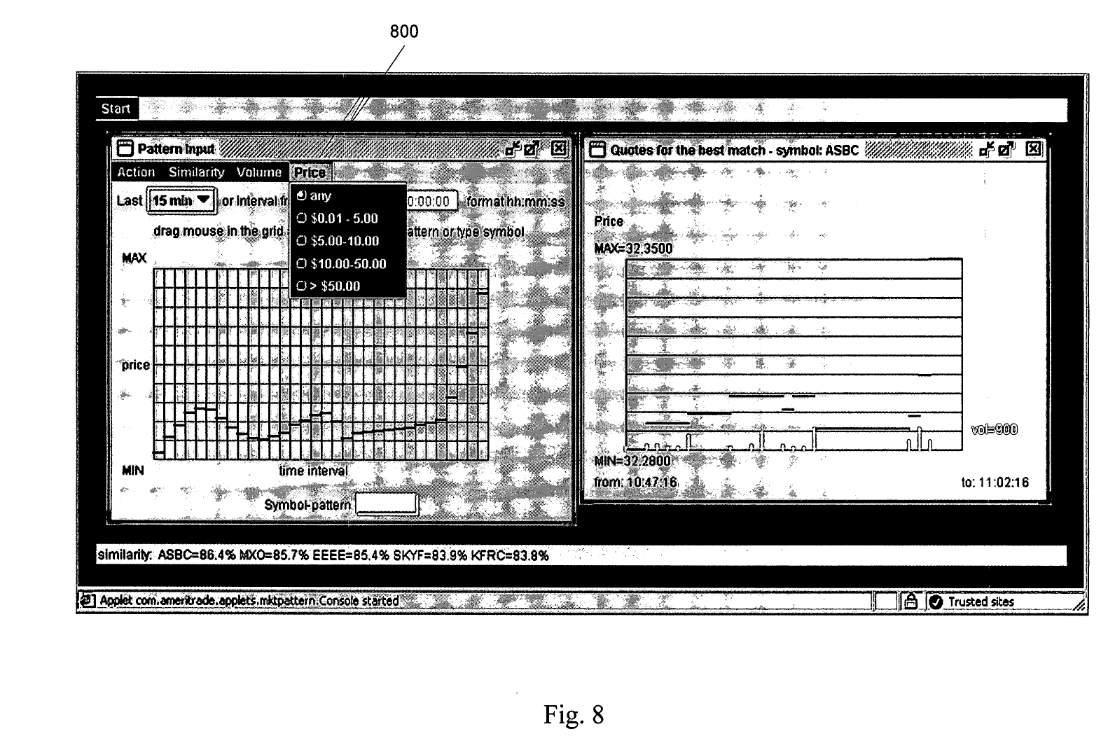

FIG. 8 illustrates in greater detail the price menu 800. Within the price menu, there are a number of selectable portions that allow the user to limit the stocks over which a pattern is desired. In this non-limiting exemplary embodiment, the ranges provided are: $0.01-$5, $5-$10, $10-$50, and above $50, however any ranges could be chosen.

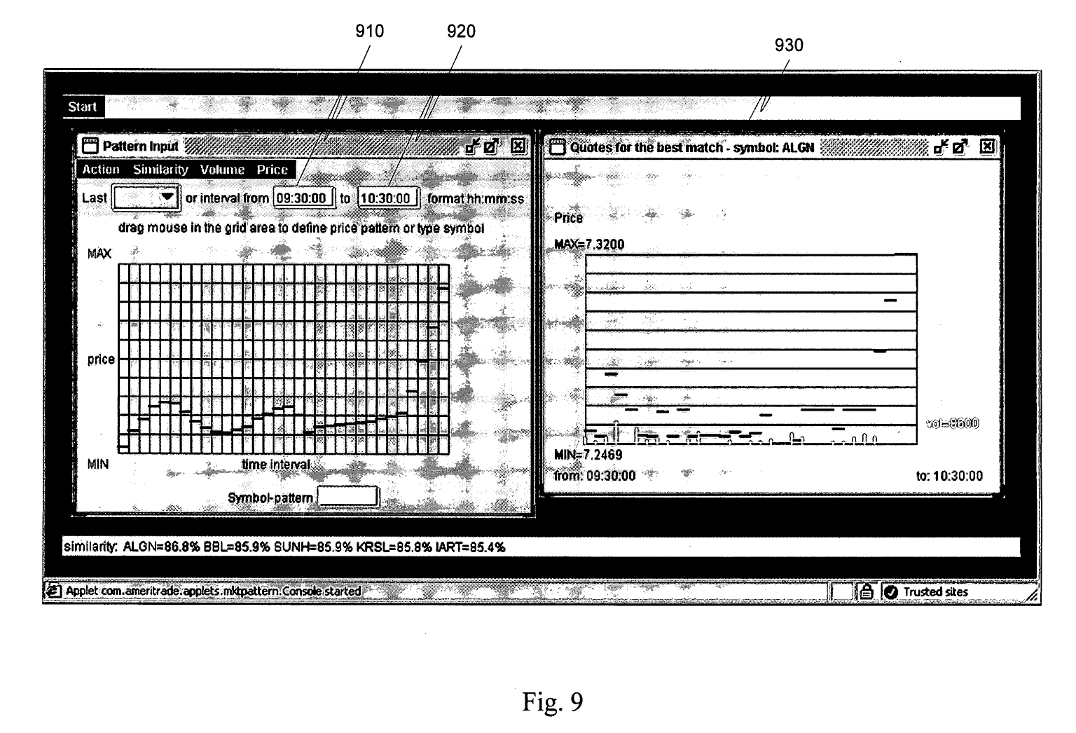

FIG. 9 illustrates an exemplary interface where a user can manually enter the time interval in dialog boxes 910 and 920. Dialog box 910 is the “from” time and the dialog box 920 is the “to” time. The “from” and “to” intervals can then be reflected in the best match window 930 in the bottom portion thereof.

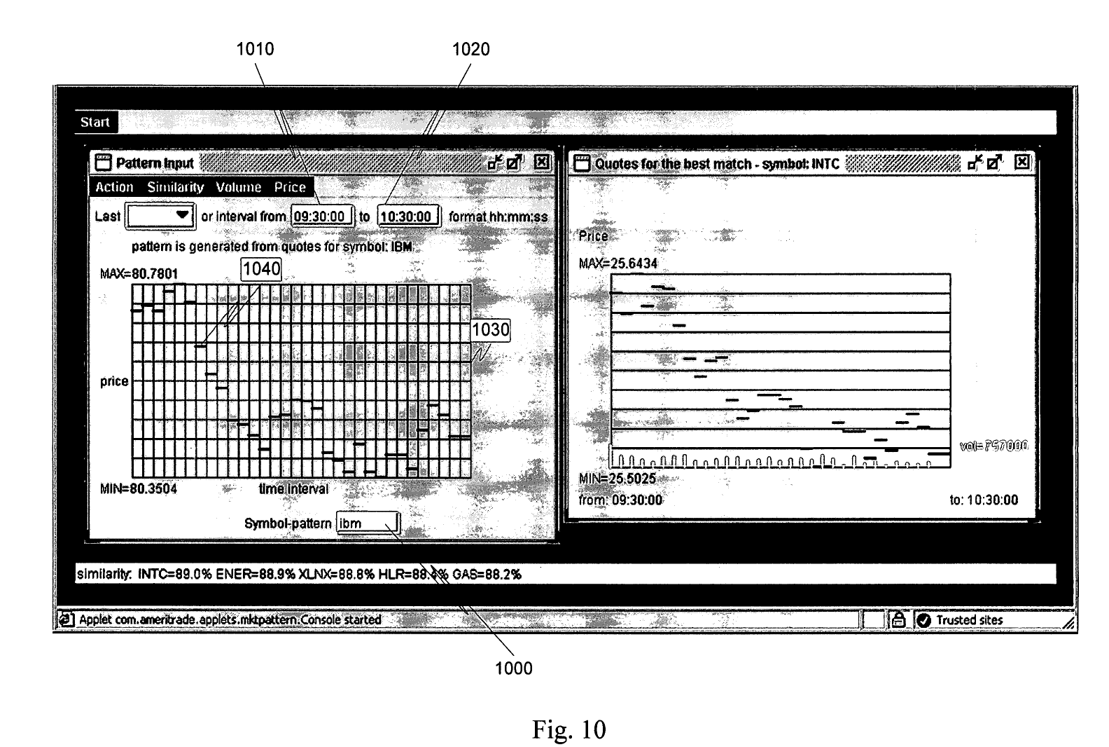

FIG. 10 illustrates the acquisition of a pattern from a known symbol. In this exemplary embodiment, a symbol is entered in the symbol-pattern dialog box 1000 and a corresponding “from” and “to” interval entered in the “from” and “to” dialog boxes 1010 and 1020, respectively. Over that time interval, the pattern is acquired and displayed in the grid 1030 as pattern 1040. A best match for that pattern can then be sought and then displayed in the best match window 1050.

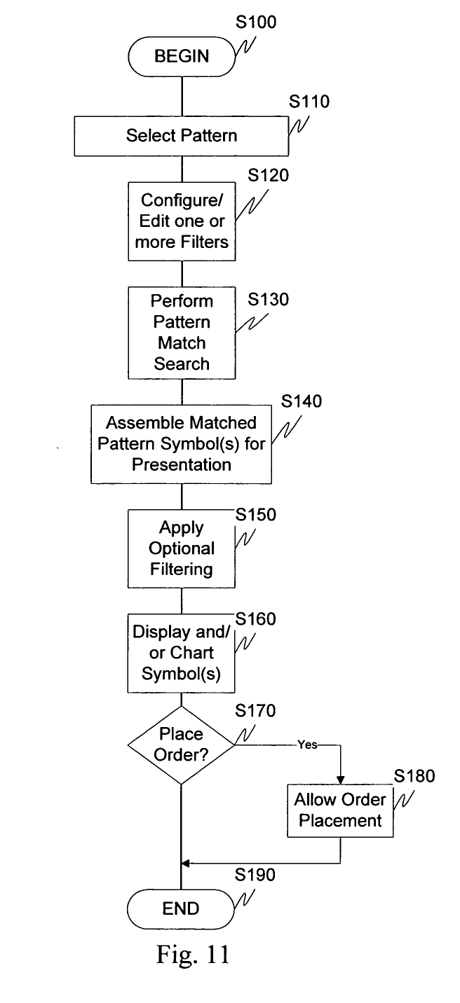

FIG. 11 illustrates an exemplary method of operation of the pattern matching system. Control begins in step S100 and continues to step S110. In step S110, a pattern is selected. Next, in step S120, one or more filters to be associated with the selected pattern are configured, edited or created. Then, in step S130, the pattern match search is performed. Control then continues to step S150.

In step S150, filtering is applied to the patterns determined to have matched the requested pattern. Next, in step S150, the patterns that match are assembled for presentation and information thereabout, such as the percentage similarity to the selected pattern displayed or charted for visualization by a user. Control then continues to step S170.

In step S170, a determination is made whether an order is to be placed. If an order is to be placed, control continues to step S180 where order placement can commence. Otherwise, control jumps to step S190 where the control sequence ends.

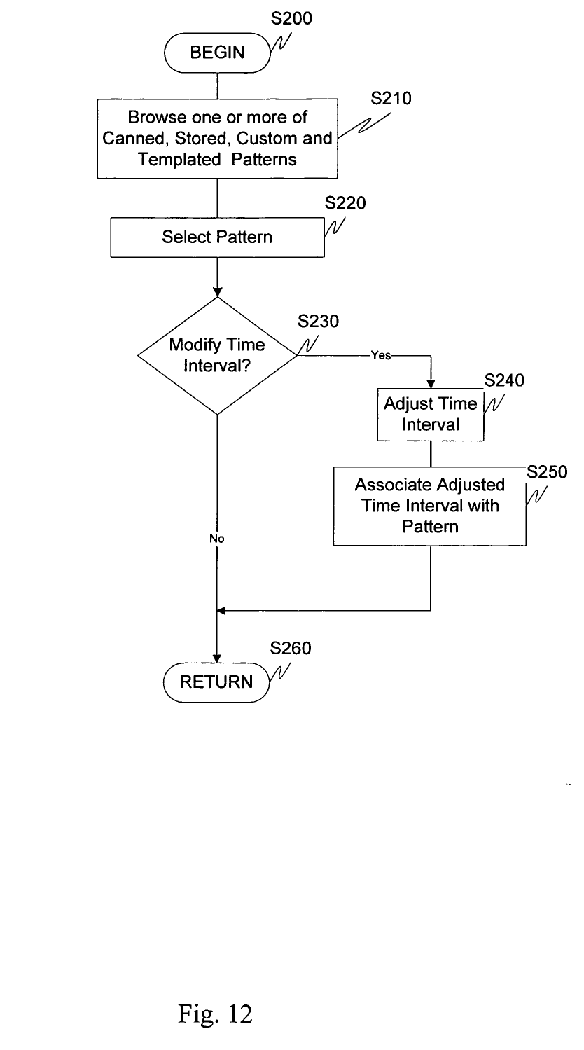

FIG. 12 illustrates in greater detail one exemplary embodiment of the select pattern step of FIG. 11. In particular, in FIG. 12, control begins in step S200 and allows the selection of one or more of canned, stored, custom and templated patterns. In step S210, the user can browse one or more of these patterns with the selection thereof occurring in step S220. Control then continues to step S230.

In step S230, a determination is made whether the time interval associated with the selected pattern should be modified. If the time interval is to be modified, control jumps to step S240. Otherwise, control continues to step S260 where the control sequence returns to step S120.

In step S240, the time interval can be adjusted. Control then continues to step S250 where the adjusted time interval is associated with the selected pattern. Control then continues back to step S120.

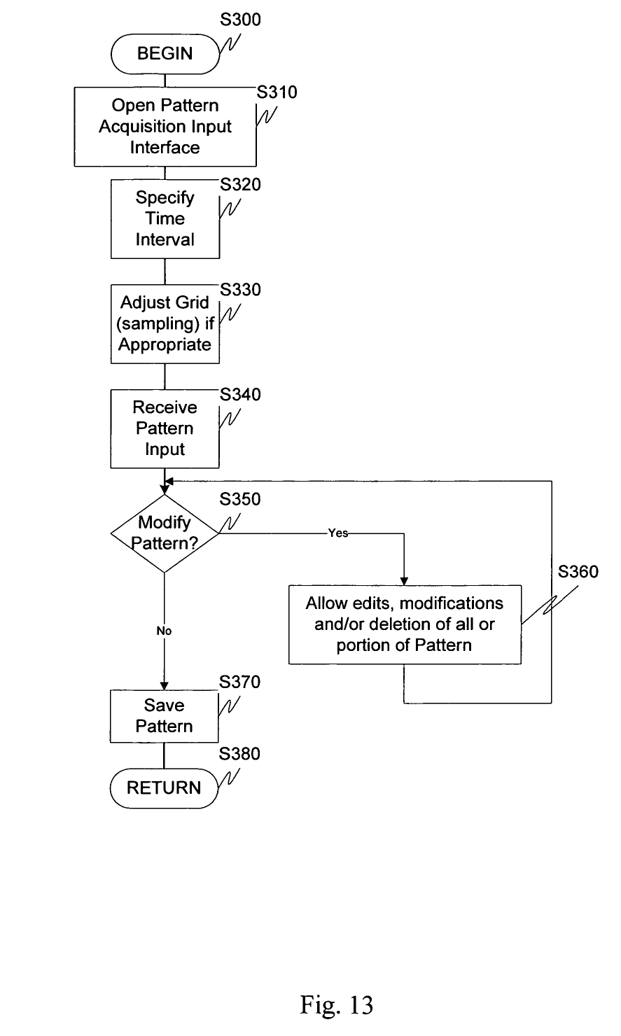

FIG. 13 outlines an alternative method of selecting a pattern in the select pattern step S110. In particular, control begins in step S300 and continues to step S310. In step S310, the pattern acquisition input interface is opened. This interface allows for a user to input a pattern, such as a custom pattern. In step S320, the user defines the time interval over which the pattern matching engine is to perform the query. Control then continues to step S330.

In step S330, and based on the specified time interval, the sampling rate of the pattern matching engine can be adjusted if necessary. Next, in step S340, the pattern acquisition module receives pattern input, for example, from a mouse or other pointing device. Next, in step S350 a determination is made whether the input pattern is to be modified. If the input pattern is to be modified, control jumps to step S360, where edits, modifications and/or deletion of the pattern can be accomplished. Control then continues back to step S350.

Otherwise, control jumps to step 370 where the pattern can be named and saved with control continuing in step S380 back to step S120.

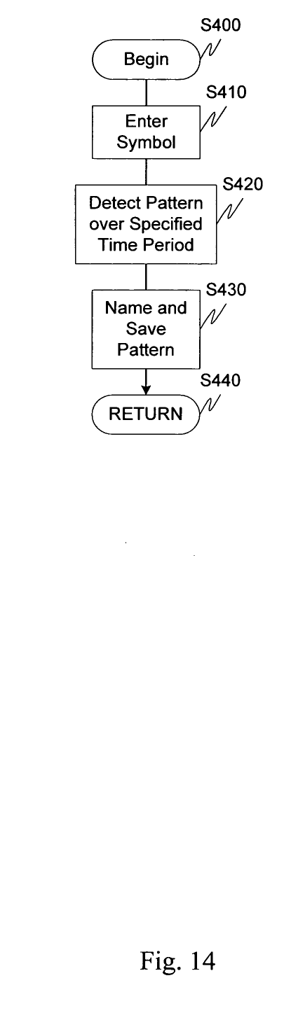

FIG. 14 outlines in greater detail another alternative to the select pattern step S110. In FIG. 14, a symbol is entered and a pattern associated therewith acquired and used as a new pattern. More specifically, control begins in step S400 and continues to step S410 where a symbol is entered. Next, in step S420, the pattern over the selected time period is detected. Then, in step S430, the detected pattern is named and saved. Control then continues to step S440 where control returns to step S120.

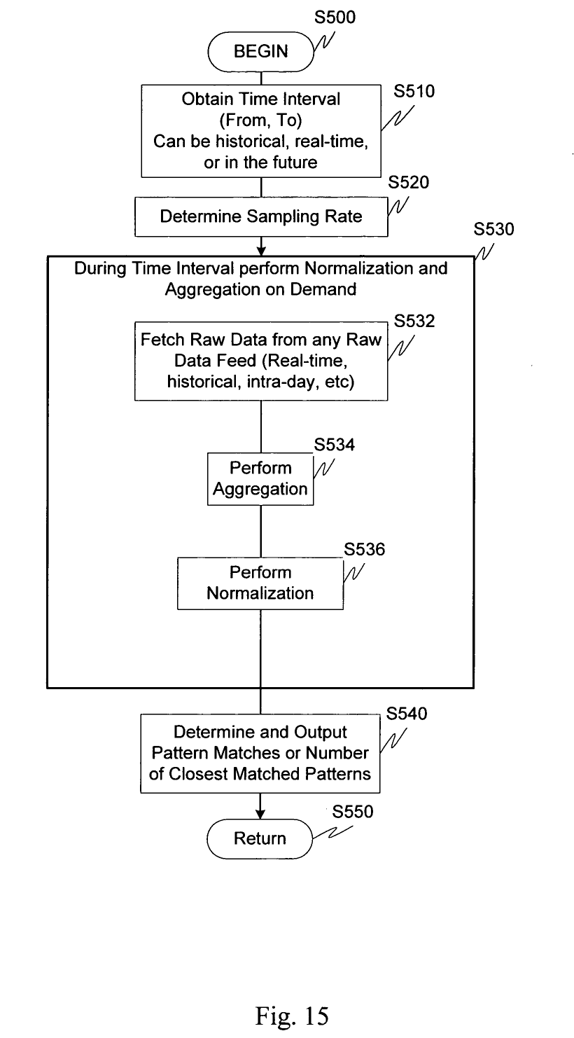

FIG. 15 illustrates in greater detail the pattern matching search step of FIG. 11. In particular, control begins in step S500 and continues to step S510. In step S510, the time interval is obtained and the sampling rate determined, if necessary, in step S520. Next, in step 530, normalization and aggregation are performed on demand for the time interval.

More particularly, in step S532, raw data is obtained. This raw data can be from one or more portions of one or more raw data feed(s), a data store, or the like and can include real-time data, historical data, intra-day data, or in general any data from any source be it historical, real-time, or near real-time or combinations thereof. Next, in step S534 aggregation of the data is performed with normalization being performed in step S536. Once aggregation and normalization are performed in step S540, one or more closest patterns are determined at the output for display as control returns back to step S160.

While the above-described flowcharts have been discussed in relation to a particular sequence of events, it should be appreciated that changes to this sequence can occur without materially effecting the operation of the invention.

The above-described system can be implemented on a computing device, such as a personal computer, PDA, internet enabled telephone, dedicated trading computer, or the like, or a separate programmed general purpose computer having a communications device. Additionally, the systems and methods of this invention can be implemented on a special purpose computer, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing a state machine that is in turn capable of implementing the processes described herein can be used to implement the quote and order system according to this invention.

Furthermore, the disclosed methods may readily be implemented in software using object or object-oriented software development environments that provide portable source code that can be used on a variety of computer or workstation platforms. Alternatively, the disclosed system may be implemented partially or fully in hardware using standard logic circuits or, for example, a VLSI design. Whether software or hardware is used to implement the systems in accordance with this invention is dependent on the speed and/or efficiency requirements of the system, particular function, and the particular software or hardware systems or microprocessor or microcomputer systems being utilized. The systems and methods illustrated herein can be readily implemented in hardware and/or software using any suitable systems or structures, devices and/or software, such as JAVA®, by those of ordinary skill in the applicable art from the functional description provided herein and with a basic general knowledge of the computer and telecommunications arts.

Moreover, the disclosed methods may be readily implemented in software executed on a programmed general purpose computer, a special purpose computer, a microprocessor, or the like. In these instances, the systems and methods of this invention can be implemented as a program embedded on a personal computer such as a JAVA®, CGI or Perl script, as a resource resigning on a server or graphics workstation, as a routine embedded in a dedicated trading system, or the like. The systems and methods of this invention can also be implemented by physically incorporating this system and method into a software and/or hardware system, such as the hardware and software systems of a computer.

It is, therefore, apparent that there has been provided, in accordance with the present invention, systems and methods for pattern matching. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A pattern matching system comprising:
a pattern management module that stores a plurality of patterns that represent trends in securities data;
a data acquisition module designed to receive one or more streams of securities data; and
a pattern matching engine cooperating with the data acquisition module and configured to analyze the received securities data and to perform a comparison between a known pattern and patterns in the received data.

2. The system of claim 1, further comprising a pattern acquisition module that cooperates with a user interface to receive an input pattern.

3. The system of claim 2, wherein the input pattern is one of user drawn or acquired from an existing security.

4. The system of claim 1, further comprising an alert and trigger module that is capable of triggering the execution of an operation upon the pattern matching engine finding a matching pattern within a predetermined similarity range.

5. The system of claim 4, wherein the operation is a trade order and the one or more streams of securities data are one or more of real-time data and historical data.

6. The system of claim 1, further comprising a data store adapted to store data from one or more streams of securities data.

7. The system of claim 1, further comprising an auditing and reporting module.

8. The system of claim 1, wherein the pattern matching engine performs the comparison based on normalization, aggregation and a distance determination step for a time period of the securities data.

9. The system of claim 8, wherein the distance determination is performed in one or more of the time domain, frequency domain, by Fourier analysis and/or multiresolution analysis.

10. The system of claim 1, further comprising a filter module.

11. A pattern matching method comprising:
selecting a pattern from one or more of canned, acquired and user input patterns;
performing a data analysis on one or more streams of incoming securities data to determine at least one similar pattern in the securities data; and
displaying the at least one similar pattern.

12. The method of claim 11, further comprising filtering one or more of the received securities data and at least one similar pattern.

13. The method of claim 11, further comprising allowing a trade to be made based on the one or more displayed similar patterns.

14. The method of claim 11, wherein the data analysis comprises one or more of a comparison based on normalization, aggregation and a distance determination step within a time period of securities data.

15. The method of claim 11, further comprising determining a sampling rate based at least on a time period.

16. The method of claim 11, wherein the one or more streams of securities data are one or more of real-time data and historical data.

17. The method of claim 11, wherein the user input pattern is received from a user interface.

18. The method of claim 11, wherein the performing step is performed in real-time or near-real time.

19. A pattern matching system comprising:
means for selecting a pattern from one or more of canned, acquired and user input patterns;
means for performing a data analysis on one or more streams of incoming securities data to determine at least one similar pattern in the securities data; and
means for displaying the at least one similar pattern.
